(19) United States
(12) Patent Application Publication
(10) Pub. No.: US 2025/0233528 A1
(43) Pub. Date: Jul. 17, 2025

(54) CONTROL DEVICE FOR MULTI-LEVEL INVERTER, PROGRAM, AND MULTI-LEVEL INVERTER

(71) Applicant: DENSO CORPORATION, Kariya-city (JP)

(72) Inventor: Masahiro KUSUMOTO, Kariya-city (JP)

(73) Assignee: DENSO CORPORATION, Kariya-city (JP)

(21) Appl. No.: 19/096,954

(22) Filed: Apr. 1, 2025

Related U.S. Application Data
(63) Continuation of application No. PCT/JP2023/039081, filed on Oct. 30, 2023.

(30) Foreign Application Priority Data
Nov. 29, 2022 (JP) 2022-190745

(51) Int. Cl. H02M 7/483; H02M 7/537; H02P 21/22; H02P 27/00

(52) U.S. Cl. CPC H02M 7/483; H02M 7/537; H02P 21/22; H02P 27/00

(57) ABSTRACT

A control device is for a multi-level inverter. The control device determines whether a suppliable current value to the electronic equipment is less than a required current value of the electronic equipment, and controls, when it is determined that the suppliable current value is less than the required current value, the plurality of switches so that current flowing in the plurality of windings is larger than when the suppliable current value is determined to be equal to or greater than the required current value.

### CROSS-REFERENCE TO RELATED APPLICATIONS

The present application is a continuation application of International Application No. PCT/JP2023/039081 filed on Oct. 30, 2023, which claims priority to Japanese Application No. 2022-190745 filed on Nov. 29, 2022. The contents of these applications are incorporated herein by reference in their entirety.

### BACKGROUND

### 1. Technical Field

This disclosure relates to a control device for a multi-level inverter, a program, and a multi-level inverter.

### 2. Related Art

JPH0937592A discloses a control device that turns switches of a three-level inverter on and off. The three-level inverter has a first capacitor and a second capacitor connected in series. By turning the switches on and off, the controller causes the three-level inverter to output three different levels of voltage that can be output from a series-connected element of the first capacitor and the second capacitor to the windings of the motor electrically connected to the switches.

### SUMMARY

The first configuration of the present disclosure provides a control device for a multi-level inverter. The multi-level inverter includes: a plurality of capacitors connected in series, and a plurality of switches electrically connected to at least one of the plurality of capacitors and at least one of a plurality of windings of the motor. The control device controls the plurality of switches to cause the multi-level inverter to output one of the multiple voltages that can be output using a series-connected element of the plurality of capacitors. The series-connected element of the plurality of capacitors can be connected in parallel to a power source. An electronic equipment can be connected in parallel to at least one of target capacitors that is part of the plurality of capacitors. The control device includes: a determination unit that determines whether a suppliable current value to the electronic equipment is less than a required current value of the electronic equipment, and a control unit that controls, when it is determined that the suppliable current value is less than the required current value, the plurality of switches so that current flowing in the plurality of windings is larger than when the suppliable current value is determined to be equal to or greater than the required current value.

The second configuration of the present disclosure provides a control device for a multi-level inverter. The multi-level inverter includes: a plurality of capacitors connected in series; and a plurality of switches electrically connected to at least one of the plurality of capacitors and at least one of a plurality of windings of the motor. The control device controls the plurality of switches to cause the multi-level inverter to output one of the multiple voltages that can be output using a series-connected element of the plurality of capacitors. The series-connected element of the plurality of capacitors can be connected in parallel to a power source. An electronic equipment can be connected in parallel to at least one of target capacitors that is part of the plurality of capacitors. The control device includes a control unit that increases the current supplied from the power source to the at least one of target capacitors via the multi-level inverter and the plurality of windings as a required current value of the electronic equipment increases, by controlling the plurality of switches.

### BRIEF DESCRIPTION OF THE DRAWING

The above and other objects, features and advantages of the present disclosure will become clearer with the following detailed description with reference to the accompanying drawings. The drawings are,

FIG. 1 shows a diagram of a vehicle;

FIG. 2 is a diagram of a control system;

FIG. 3 shows a block diagram of processes that generates the operating signals for each switch;

FIG. 4 shows how the instruction current vector is set;

FIG. 5 is a flowchart showing the control procedures performed by the control device,

FIG. 6 shows an example of an instruction current vector;

FIG. 7 shows an example of auxiliary device current supply control;

FIG. 8 shows an example of auxiliary device current supply control;

FIG. 9 is a time chart showing an example of auxiliary device current supply control;

FIG. 10 is a time chart showing an example of control in according to a comparative example;

FIG. 11 shows an example of auxiliary device current supply control according to a second embodiment;

FIG. 12 shows an example of auxiliary device current supply control;

FIG. 13 is a diagram of the control system for another embodiment;

FIG. 14 is a diagram of the vehicle for another embodiment;

FIG. 15 is a diagram of the control system for another embodiment.

### DETAILED DESCRIPTION OF THE PREFERRED EMBODIMENTS

In the three-level inverter, a power source may be connected in parallel to the series-connected element of the first capacitor and the second capacitor, and an electronic equipment may be connected in parallel to either the first capacitor or the second capacitor. In this case, when the current supplied to an electronic equipment using the power source as the power supply source is less than the required current of the electronic equipment, the voltage of the capacitor to which the electronic equipment is connected in parallel may drop significantly. As a result, the electronic equipment may not be able to operate properly.

This issue arises not only for the three-level inverter, but also for multi-level inverters that output more than three different levels of potential.

This disclosure aims to provide a control device for a multi-level inverter, a program, and a multi-level inverter that can suppress a large drop in the voltage of the capacitor to which the electronic equipment is connected in parallel.

The first configuration of the present disclosure provides a control device for a multi-level inverter. The multi-level inverter includes: a plurality of capacitors connected in series, and a plurality of switches electrically connected to at least one of the plurality of capacitors and at least one of a plurality of windings of the motor. The control device controls the plurality of switches to cause the multi-level inverter to output one of the multiple voltages that can be output using a series-connected element of the plurality of capacitors. The series-connected element of the plurality of capacitors can be connected in parallel to a power source. An electronic equipment can be connected in parallel to at least one of target capacitors that is part of the plurality of capacitors. The control device includes: a determination unit that determines whether a suppliable current value to the electronic equipment is less than a required current value of the electronic equipment, and a control unit that controls, when it is determined that the suppliable current value is less than the required current value, the plurality of switches so that current flowing in the plurality of windings is larger than when the suppliable current value is determined to be equal to or greater than the required current value.

In the first configuration above, the series-connected element of the plurality of capacitors is connected in parallel to the power source, and the target capacitor, which is part of the plurality of capacitor, is connected in parallel to the electronic equipment. When the current value supplied to electronic equipment using the power source as the power supply source is less than the required current value of electronic equipment, the voltage of the target capacitor drops. To control the voltage drop of target capacitor, it is necessary to feed power to the target capacitor. Here, the impedance of the DC component of capacitor is very large. Therefore, although the series-connected element of plurality of capacitors is connected in parallel to the power source, the power that can be supplied directly from the power source to the capacitor is very small or cannot be supplied directly from the power source to the capacitor. To supply sufficient power from the power source to the target capacitor, it is necessary to supply power from the power source to the target capacitor through the inverter and the winding by controlling the switches provided by the multi-level inverter.

In view of this point, when it is determined that the suppliable current value is less than the required current value, the plurality of switches is controlled so that current flowing in the plurality of windings is larger than when the suppliable current value is determined to be equal to or greater than the required current value. When the current supplied to the winding is increased, the current that can be supplied to the target capacitor is also increased. Therefore, the voltage drop in the target capacitor can be suppressed.

The second configuration of the present disclosure provides a control device for a multi-level inverter. The multi-level inverter includes: a plurality of capacitors connected in series; and a plurality of switches electrically connected to at least one of the plurality of capacitors and at least one of a plurality of windings of the motor. The control device controls the plurality of switches to cause the multi-level inverter to output one of the multiple voltages that can be output using a series-connected element of the plurality of capacitors. The series-connected element of the plurality of capacitors can be connected in parallel to a power source. Electronic equipment can be connected in parallel to at least one of target capacitors that is part of the plurality of capacitors. The control device includes a control unit that increases the current supplied from the power source to the at least one of target capacitors via the multi-level inverter and the plurality of windings as a required current value of the electronic equipment increases, by controlling the plurality of switches.

According to the second configuration above, the plurality of switches is controlled to increase the current supplied from the power source to the at least one of target capacitors via the multi-level inverter and the plurality of windings as a required current value of the electronic equipment increases. This allows the current supplied to the electronic equipment to increase as the increase in the required current value, thereby suitably suppressing the voltage drop in target capacitor.

### First Embodiment

The following is a description of a first embodiment embodying the control device of the present disclosure, with reference to the drawings. In this embodiment, the control device is mounted on an electric vehicle such as an electric vehicle or a hybrid vehicle.

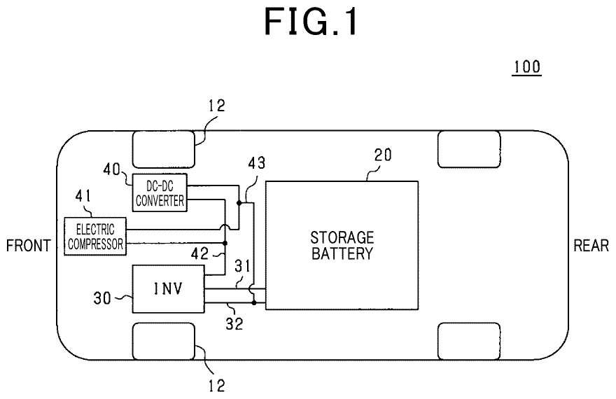

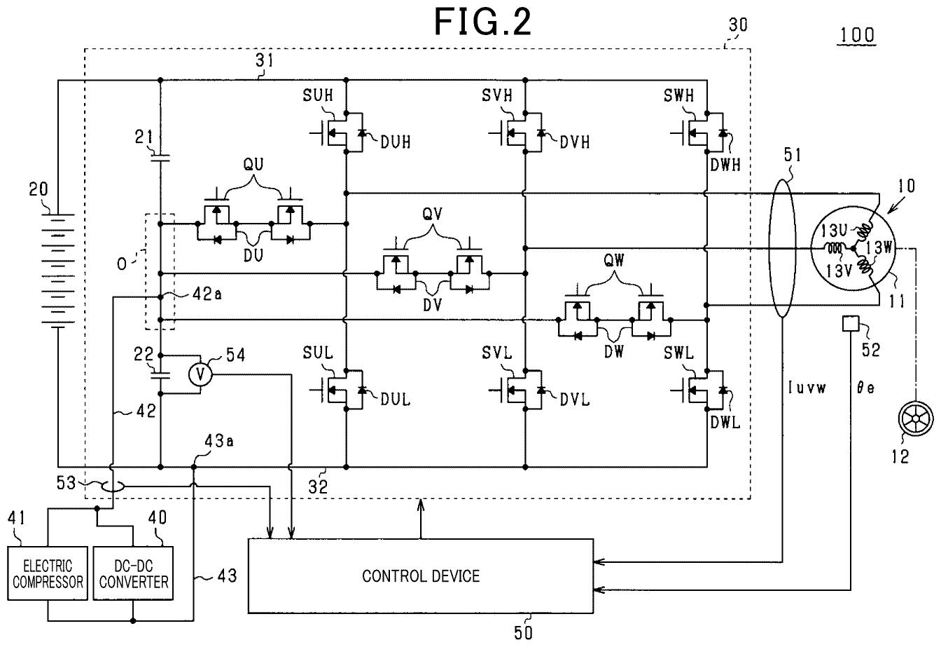

FIG. 1 shows a plan view of the schematic configuration of the vehicle 100, and FIG. 2 shows a diagram of the control system mounted on the vehicle 100. As shown in FIGS. 1 and 2, vehicle 100 has a motor 10, a storage battery 20, and an inverter 30. Motor 10 is the vehicle's on-board main unit. A rotor 11 of the motor 10 can transmit power to drive wheels 12 of the vehicle 100. In this embodiment, the motor 10 is a three-phase synchronous motor and has star-connected phase U winding 13U, phase V winding 13V, and phase W winding 13W as stator windings. The phase U winding 13U, the phase V winding 13V, and the phase W winding 13W are shifted by 120° in an electrical angle. The motor 10 is, for example, a permanent magnet synchronous motor.

The storage battery 20 is electrically connected to the motor 10 via the inverter 30. The storage battery 20 is a power source that supplies drive power to the motor 10. In this embodiment, the storage battery 20 is a battery assembly that includes a series-connected element of battery cells, for example. The battery cell is, for example, a secondary battery such as a lithium-ion battery. The voltage between terminals of the storage battery 20 is, for example, 600-800 V.

The inverter 30 is a power conversion circuit. The inverter 30 converts DC power supplied from storage battery 20 to three-phases AC power by switching control and supplies the converted AC power to the motor 10. In parallel to inverter 30 and storage battery 20, a first capacitor 21 and a second capacitor 22 are provided. The first capacitor 21 and the second capacitor 22 are connected in series. The storage battery 20 is connected in parallel to the series-connected element of the first capacitor 21 and the second capacitor 22. In this configuration, the capacitance of the first capacitor 21 and the capacitance of the second capacitor 22 are the same. The first capacitor 21 and the second capacitor 22 may be external to the inverter 30 or may be built into the inverter 30.

In this configuration, the inverter 30 is a T-type three-level inverter. The inverter 30 has series-connected element corresponding to three-phases, including series-connected element of upper arm switch SUH and lower arm switch SUL, series-connected element of upper arm switch SVH and lower arm switch SVL, and series-connected element of upper arm switch SWH and lower arm switch SWL. Each switch SUH to SWL is a voltage-controlled semiconductor switching device, more specifically, each of the switches SUH to SWL is an N-channel MOSFET. Therefore, the high potential terminal of each of the switches SUH to SWL is the drain and the low potential terminal of each of the switches SUH to SWL is the source. The switches SUH, SVH, SWH, SUL, SVL, and SWL has a body diode DUH, DVH, DWH, DUL, DVL, and DWL respectively.

The source of the phase U upper arm switch SUH is connected to the drain of the phase U lower arm switch SUL. A connecting point of the phase U upper arm switch SUH and the phase U lower arm switch SUL is connected to a first terminal of the phase U winding 13U. The source of the phase V upper arm switch SVH is connected to the drain of the phase V lower arm switch SVL. A connecting point of the phase V upper arm switch SVH and the phase V lower arm switch SVL is connected to a first terminal of the phase V winding 13V. The source of phase W upper arm switch SWH is connected to the drain of phase W lower arm switch SWL. A connection point of phase W upper arm switch SWH and phase W lower arm switch SWL is connected to a first terminal of the phase W winding 13W. A second terminal of each of the phase U winding 13U, the phase V winding 13V, and the phase W winding 13W is connected to the drain of the phase V winding 13W. The second terminals of the phase U winding 13U, the phase V winding 13V, and the phase W winding 13W are connected to each other.

The drain of each of the upper arm switches SUH to SWH is connected by positive bus 31, such as a bus bar. The positive bus 31 is connected to the first terminal of positive terminal and first capacitor 21 of the storage battery 20. The second terminal of first capacitor 21 is connected to the first terminal of second capacitor 22 via neutral point O. The source of each of the lower arm switches SUL to SWL is connected to a negative bus 32, such as a bus bar. The negative bus 32 is connected to the second terminals of negative terminal and second capacitor 22 of the storage battery 20.

The inverter 30 has a phase U clamp switch QU, a phase V clamp switch QV, and a phase W clamp switch QW, each of which conducts and interrupts current in both directions. In this embodiment, each of the phase U clamp switch QU, the phase V clamp switch QV, and the phase V clamp switch QW is a voltage-controlled semiconductor switching device, and specifically, is an N-channel MOSFET. The phase U clamp switch QU has a body diode DU, the phase V clamp switch QV has a body diode DV, and the phase V clamp switch QW has a body diode DW.

Taking phase U as an example, the phase U clamp switch QU has two switches, and the sources of the two switches are connected to each other. The drain of one of the two switches is connected to the connection point of the phase U upper arm switch SUH and the phase U lower arm switch SUL, and the drain of the other is connected to a neutral point O. Each of the phase U clamp switch QU, the phase V clamp switch QV, and the phase W clamp switch QW, when turned on, allows bidirectional current flow, and when turned off, prevents bidirectional current flow.

The vehicle 100 has a DC-DC converter 40 and an electric compressor 41, each of which is an example of “electronic equipment”. The DC-DC converter 40 is driven to step down the output voltage of the storage battery 20 to provide power to a low-voltage battery (e.g., a 12V auxiliary battery) not shown. The electric compressor 41 is part of an interior air conditioning system and is driven by receiving power from the storage battery 20 to circulate the refrigerant in the onboard refrigeration cycle. In addition to (or instead of) the DC-DC converter 40 and the electric compressor 41, the vehicle 100 may also be equipped with a heater or another device as “electronic equipment”. The heater is, for example, a PTC heater.

In this embodiment, the DC-DC converter 40 and the electric compressor 41 are connected in parallel to the second capacitor 22. Specifically, a neutral point terminal 42a is provided to the neutral point O to connect the DC-DC converter 40 and the electric compressor 41 in parallel to the second capacitor 22, and a negative bus terminal 43a is provided to the negative bus 32. The neutral point terminal 42a and the negative bus terminal 43a are external terminals to connect the electronic equipment outside the inverter 30 to the inverter 30. The positive terminal of the electric compressor 41 is connected to the neutral point terminal 42a via a neutral line 42. The positive terminal of the DC-DC converter 40 is connected to the neutral line 42. The negative terminal of the electric compressor 41 is connected to the negative bus terminal 43a via a negative line 43. The negative terminal of the DC-DC converter 40 is connected to the negative line 43. This reduces the voltage applied to the DC-DC converter 40 and the electric compressor 41 compared to when the DC-DC converter 40 and the electric compressor 41 are connected in parallel to the storage battery 20. In this configuration, the second capacitor 22 is an example of “target capacitor”.

FIGS. 1 and 2 show a configuration in which the positive terminal of the DC-DC converter 40 is connected to, branching from the neutral line 42, the neutral point O. However, this is not limited to this configuration. For example, multiple connectors may be attached to the inverter 30 for connection to the neutral point O, and the positive terminal of the DC-DC converter 40 and the positive terminal of the electric compressor 41 may be connected to one of the multiple connectors respectively. FIGS. 1 and 2 show a configuration in which the negative terminal of the DC-DC converter 40 is connected to, branching from the negative line 43, the negative terminal of storage battery 20 and, but this is not limited to this configuration. For example, multiple connectors may be provided in the storage battery 20 to allow connection to the negative terminal of storage battery 20, and the negative terminal of the DC-DC converter 40 and the negative terminal of the electric compressor 41 may be connected to one of the multiple connectors respectively.

The vehicle 100 has a control device 50, a phase current sensor 51, a rotation angle sensor 52, a auxiliary device current sensor 53 and a voltage sensor 54. The phase current sensor 51 detects the phase U, V, W currents Iuvw flowing in the motor 10. The phase current sensor 51 should be able to detect at least two of the three phase currents. The rotation angle sensor 52 is a resolver, for example, to detect the electric angle θe of the motor 10. The auxiliary device current sensor 53 detects the currents flowing in the DC-DC converter 40 and the electric compressor 41. In this system, the auxiliary device current sensor 53 detects the current flowing in the neutral line 42. The voltage sensor 54 detects the voltage between terminals of the second capacitor 22. The detected values of each of the sensors 51, 52, 53, 54 are input to the control device 50. The vehicle 100 may be equipped with a voltage sensor that detects the voltage between terminals of the first capacitor 21.

The control device 50 is mainly composed of a microcontroller (equivalent to a “computer”), and the microcontroller includes a CPU. The functions provided by the microcontroller can be provided by software recorded in a substantive memory device and a computer executing it, software only, hardware only, or a combination thereof. For example, if the microcontroller is provided by electronic circuits that are hardware, it can be provided by digital or analog circuits containing many logic circuits. For example, the microcontroller executes a program stored in a non-transitory tangible storage medium as its own storage unit. The program includes, for example, the program for the process shown in FIG. 5, etc. When the program is executed, the method corresponding to the program is performed. The storage medium is, for example, a nonvolatile memory. The program stored in the storage part can be updated via a network, such as the Internet, for example.

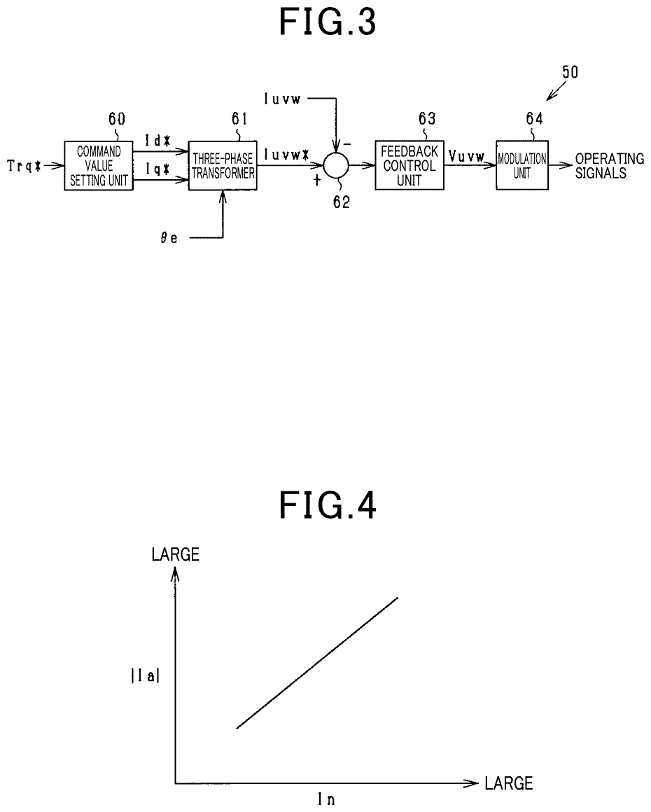

The control device 50 generates drive commands to turn on and off each of the switches SUH to SWL, QU to QW of the inverter 30. The control device 50 turns on and off each of the witches SUH to SWL, QU to QW based on the generated drive commands. In the following, the process of generating drive commands for each of the switches SUH to SWL, QU to QW by the control device 50 is described with reference to FIG. 3.

The control device 50 has a command value setting unit 60. A command torque Trq* output from the upper controller (not shown) is input to the command value setting unit 60. The command value setting unit 60 sets a d-axis instruction current Id* and a q-axis instruction current Iq* in the 2-phase rotation coordinate system (d-q coordinate system) based on the command torque Trq*. In this system, the command value setting unit 60 sets the d-axis instruction current Id* and the q-axis instruction current Iq* based on minimum current maximum torque control (MTPA).

The control device 50 has a three-phase transformer 61. The d-axis instruction current Id* and the q-axis instruction current Iq* are input to the three-phase transformer 61. The three-phase transformer 61 converts the d-axis instruction current Id* and the q-axis instruction current Iq* to the phase U, V, Ws instruction current Iuvw* in the three-phase fixed coordinate system based on the electric angle θe. The detected value of the rotation angle sensor 52 may be used as the electrical angle θe.

The control device 50 has a deviation calculation unit 62. The phase U, V, W instruction current Iuvw* and the phase U, V, W current Iuvw are input to the deviation calculation unit 62. The deviation calculation unit 62 calculates a phase U current deviation by subtracting the phase U current from the phase U instruction current. The deviation calculation unit 62 calculates a phase V current deviation by subtracting the phase V current from the phase V instruction current. The deviation calculation unit 62 calculates a phase W current deviation by subtracting the phase W current from the phase W instruction current. The detected value of phase current sensor 51 should be used as the phase U, V, W current Iuvw.

The control device 50 has a feedback control unit 63. The phase U, V, W current deviation is input to the feedback control unit 63. Based on the phase U, V, W current deviation, the feedback control unit 63 calculates phase U, V, W instruction voltage Vuvw, each of them being a control input of the feedback control to cause the phase U, V, W current Iuvw to approach the phase U, V, W instruction current Iuvw*. The above feedback control can be, for example, PI control.

The control device 50 has a modulation unit 64. The phase U, V, W instruction voltage Vuvw is input to the modulation unit 64. Based on the phase U, V, W instruction voltage Vuvw, the modulation unit 64 generates operating signals for each of the switches SUH to SWL and QU to QW of the inverter 30. For example, the modulation unit 64 may generate the operating signals for each of the switches SUH to SWL and QU to QW by space vector modulation control or triangular wave comparison PWM control.

When the current value supplied to the DC-DC converter 40 and the electric compressor 41 from the storage battery 20 as the power supply source, falls below the required current value of the DC-DC converter 40 and the electric compressor 41, the voltage of the second capacitor 22 can drop significantly. As a result, the voltage of the second capacitor 22 may fall below the lower limit voltage at which the DC-DC converter 40 and the electric compressor 41 can operate, and the DC-DC converter 40 and the electric compressor 41 may not be operated properly.

To suppress the voltage drop in the second capacitor 22, it is necessary to supply power to the second capacitor 22. However, since the impedance of the DC component of capacitors are very large, the power that can be supplied directly from the storage battery 20 to the second capacitor 22 is very small or cannot be supplied directly from the storage battery 20 to the second capacitor 22 when series-connected element of the first capacitor 21 and the second capacitor 22 are connected in parallel to the storage battery 20. To supply enough power from the storage battery 20 to the second capacitor 22, it is necessary to supply power from the storage battery 20 to the second capacitor 22 through the inverter 30 and each of the phase windings 13U to 13W by controlling the switches SUH to SWL, QU to QW respectively.

Therefore, as shown in FIG. 4, the control device 50 increases the size of the instruction current vector Ia, which is determined based on the d-axis instruction current Id* and the q-axis instruction current Iq*, as the sum of requested current values of the DC-DC converter 40 and the electric compressor 41 (hereafter, requested current value In) is larger. In this case, each of the switches SUH to SWL and QU to QW is controlled so that the current supplied to the second capacitor 22 is increased as the size of the instruction current vector Ia is increased.

Depending on the driving conditions of the motor 10, each of the switches SUH to SWL and QU to QW may be controlled to realize a small size of the instruction current vector Ia. Then the current supply to the DC-DC converter 40 and the electric compressor 41 using the storage battery 20 as the power supply source may fall below the required current value In. For example, in a situation where the driving load is small, such as a situation where the speed of the vehicle 100 is low or the torque of the motor 10 is low, the size of the instruction current vector Ia becomes small and the current supply to the DC-DC converter 40 and the electric compressor 41 is reduced. In this case, the current supply may fall below the required current value In. In contrast, according to this embodiment, the size of the instruction current vector Ia is intentionally increased in the situation where the current supply to the DC-DC converter 40 and the electric compressor 41 using the storage battery 20 as the power supply source may fall below the required current value In.

FIG. 5 shows the control procedure performed by the control device 50. This control is performed repeatedly, for example, at a predetermined control cycle.

In step S10, the control device 50 determines whether the suppliable current value Is to the DC-DC converter 40 and the electric compressor 41 using the storage battery 20 as the power supply source is greater than or equal to the required current value In. In this embodiment, the suppliable current value Is is calculated based on the detection value of the phase current sensor 51, and the required current value In is calculated based on the detection value of the auxiliary device current sensor 53. When a positive determination is made in step S10, the control device 50 proceeds to step S11. On the other hand, when a negative determination is made in step S10, the control device 50 proceeds to step S12.

The suppliable current value Is may be calculated based on values other than the detected value of the phase current sensor 51. For example, the suppliable current value Is may be calculated based on the command torque Trq* and the detected value of the rotation angle sensor 52. The required current value In may be derived based on values other than the detected value of the auxiliary device current sensor 53. For example, the required current value In may be a predetermined set value. In this case, the more electronic equipment of the DC-DC converter 40 and the electric compressor 41 that are operating, the higher the required current value In may be dynamically set to a higher value.

In step S11, the control device 50 performs a normal inverter control. When performing the normal inverter control, the control device 50 sets the d-axis instruction current Id* and the q-axis instruction current Iq* according to the minimum current maximum torque control (MTPA) using the command torque Trq* as input. The control device 50 converts the set d-axis instruction current Id* and the q-axis instruction current Iq* to the phase U, V, W instruction current Iuvw* and calculates the phase U, V, W instruction voltage Vuvw, each of them being a control input of the feedback control to cause the phase U, V, W current Iuvw to approach the phase U, V, W instruction current Iuvw. The control device 50 generates operating signals for each of the switches SUH to SWL and QU to QW of the inverter 30 based on the phase U, V, W instruction voltage Vuvw. This controls the torque of the motor 10 to the command torque Trq*.

In step S12, an auxiliary device current supply control is performed. The auxiliary device current supply control is a control to generate operating signals for each switch SUH to SWL and QU to QW of the inverter 30 so that the current amplitude flowing in each phase winding 13U to 13W is larger than in the normal inverter control. When the auxiliary device current supply control is performed, the torque of motor 10 is controlled to the command torque Trq* and the size of the instruction current vector Ia is increased compared to the normal inverter control.

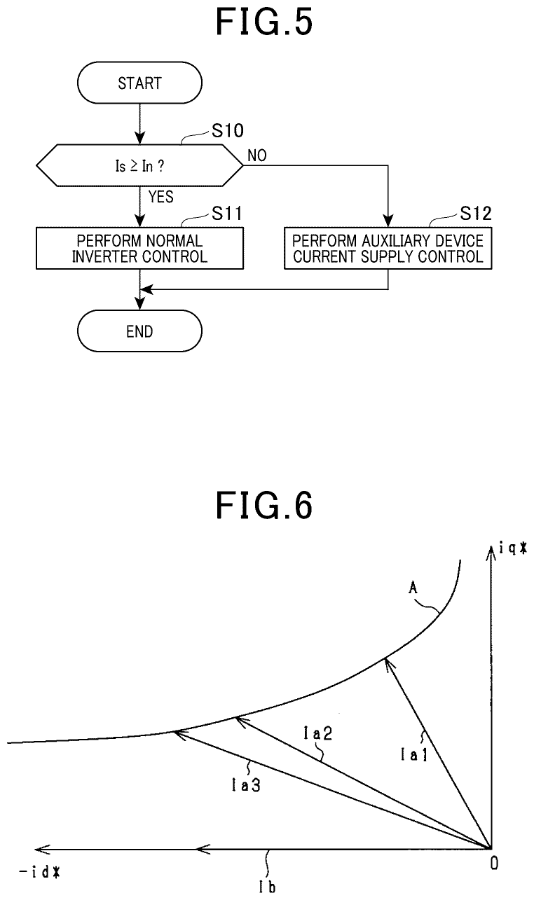

Specifically, when performing the auxiliary device current supply control, the control device 50 increases the size of the instruction current vector la compared to the normal inverter control by increasing the d-axis instruction current Id* flowing in each of the phase windings 13U to 13W compared to the normal inverter control. FIG. 6 illustrates the instruction current vector Ia1 in the normal inverter control and the instruction current vectors Ia2 and Ia3 in the auxiliary device current supply control. The instruction current vectors Ia2 and Ia3 in the auxiliary device current supply control have the d-axis instruction current Id* increased to the negative side compared to the instruction current vector Ia1 in the normal inverter control. In other words, the instruction current vectors Ia2 and Ia3 are set so that the weakening field current is increased compared to the instruction current vector Ia1. This increases the size of the instruction current vectors Ia2 and Ia3 in the auxiliary device current supply control compared to the size of the instruction current vector Ia1 in the normal inverter control.

When performing the auxiliary device current supply control, it is desirable that the control device 50 increase the size of the instruction current vector Ia as described in FIG. 4, as the larger the requested current value In is. For example, as shown in FIG. 6, the control device 50 may set the instruction current vector, when performing the auxiliary device current supply control, to Ia2 when the required current value In is smaller, and to Ia3 when the required current value In is larger, in which the d-axis instruction current Id* is increased to the negative side compared to Ia2.

When performing auxiliary device current supply control, the control device 50 may control each of the switches SUH to SWL, QU to QW so that the d-axis instruction current Id* is increased and the operating point determined by the d-axis current and the q-axis current in each phase winding 13U to 13W is on the equal torque curve of the motor 10 with the same curve as when the normal inverter control is performed. For example, as shown in FIG. 6, when performing the auxiliary device current supply control, the control device 50 may control the instruction current vectors Ia2 and Ia3 on the equal torque curve A in which the instruction current vector Ia1 for the normal inverter control exists on.

When performing the auxiliary device current supply control, when the control device 50 does not drive the rotor 11 of the motor 10 and keeps the motor 10 in a state of rotational standstill, the control device 50 may control each of the switch SUH to SWL and QU to QW so that only the d-axis currents out of the d-axis current and the q-axis current flow to each of the phase windings 13U to 13W. In this case, the instruction current vector Ib at the auxiliary device current supply control is set on the d-axis, as shown in FIG. 6. This allows the control device 50 to increase the current flowing in each of the phase windings 13U to 13W while the q-axis current flowing in each of the phase windings 13U to 13W is set to zero and the rotor 11 of the motor 10 is prevented from rotating. The control device 50 may cause the instruction current vector Ib in the auxiliary device current supply control to be a value other than 0 for the q-axis current within the range where the rotor 11 is allowed to be driven to rotate.

When performing the auxiliary device current supply control, when the control device 50 keeps the motor 10 in a state of rotational standstill, the control device 50 turns on the clamp switch in the specific phase determined according to the electric angle θe of the motor 10 among the phase U, V, W clamp switches QU, QV, and QW, and turns off the lower arm switch SUL, SVL, and SWL in each phase. The control device 50 turns on and off the upper arm switch in each phase other than the specified phase, so that the d-axis current flows in each phase winding 13U-13W.

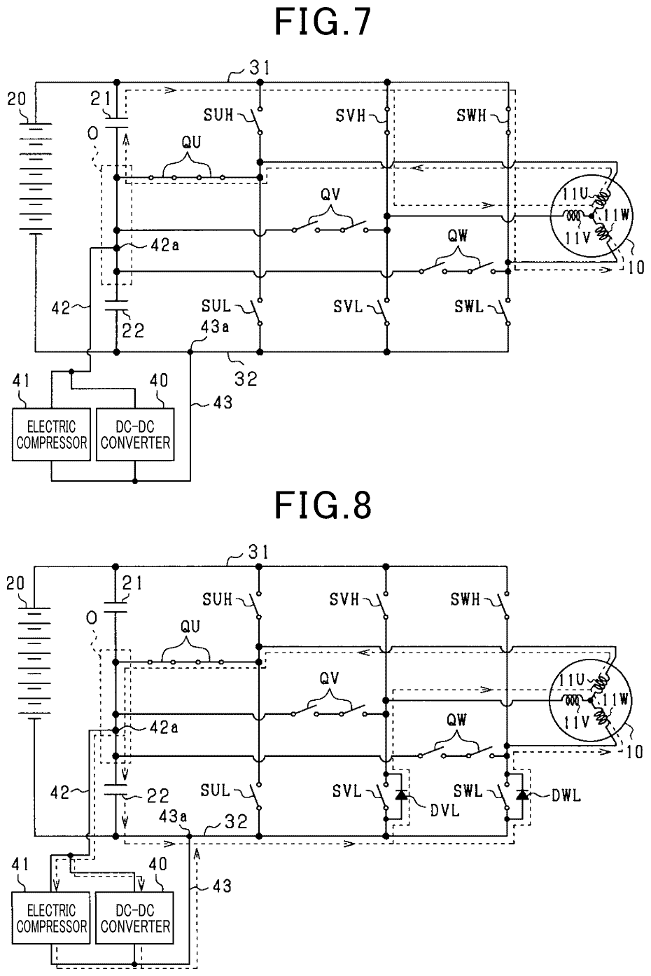

FIGS. 7 and 8 show examples of the auxiliary device current supply control in the case where the rotor 11 of the motor 10 is kept in a state of a rotational standstill. The case where the specific phase is phase U is explained here.

When the specified phase is phase U, the phase U clamp switch QU is turned on, the phase V clamp switch QV and the phase W clamp switch QW, each of the phase lower arm switches SUL to SWL and the phase U upper arm switch SUH are turned off, and the phase V upper arm switch SVH and the phase W upper arm switch SWH are turned on and off.

FIG. 7 shows the current path when the phase V upper arm switch SVH and the phase W upper arm switch SWH are turned on. In this case, current flows in a closed circuit that includes the first capacitor 21, the phase V upper arm switch SVH, the phase W upper arm switch SWL, each of the phase windings 13U to 13W, and the phase U clamp switch QU. This causes magnetic energy to be stored in each of the phase windings 13U, 13V, and 13W.

FIG. 8 shows the current path when the phase V upper arm switch SVH and the phase W upper arm switch SWH are turned off. In this case, a closed circuit is formed including the second capacitor 22, the DC-DC converter 40, the electric compressor 41, the phase V lower arm diode DVL, the phase W lower arm diode DWL, each of the phase windings 13U to 13W and the phase U clamp switch QU. Current flows as the magnetic energy stored in each of the phase windings 13U to 13W is released. By this way, power is supplied to the second capacitor 22, the DC-DC converter 40 and the electric compressor 41.

When the specific phase is phase V, the phase V clamp switch QV is turned on, the phase U clamp switch QU, the phase W clamp switch QW, each phase of the lower arm switch SUL to SWL and the phase V upper arm switch SVH are turned off, and the phase U upper arm switch SUH and the phase W upper arm switch SWH are turned on and off. When the specified phase is phase W, the phase W clamp switch is turned on, the phase U clamp switch QU, the phase V clamp switch QV, each of the lower arm switches SUL to SWL and the phase W upper arm switch SWH are turned off, and phase U upper arm switch SUH and phase V upper arm switch SVH are turned on and off.

When the specified phase is phase U and phase V, the phase U clamp switch QU and the phase V clamp switch QV are turned on, and the phase W clamp switch QW, each of the lower arm switch SUL to SWL, the phase U upper arm switch SUH and the phase V upper arm switch SVH are turned off, and the phase W upper arm switch SWH is turned on and off. When the specified phase is phase V and phase W, the phase V clamp switch QV and the phase W clamp switch QW are turned on, and the phase U clamp switch QU, each of the lower arm switch SUL to SWL, the phase V upper arm switch SVH and the phase W upper arm switch SWH are turned off, and the phase U upper arm switch SUH is turned on and off. When the specified phase is phase U and phase W, the phase U clamp switch QU and the phase W clamp switch QW are turned on, and the phase V clamp switch QW, each of the lower arm switch SUL to SWL, the phase U upper arm switch SUH and the phase W upper arm switch SWH are turned off, and the phase V upper arm switch SVH is turned on and off.

The specific phase may be fixed or changed dynamically during the period in which the auxiliary device current supply control is performed. For example, the operating signal may be generated so that the phase U is the specified phase for half of one switching cycle of the auxiliary device current supply control, and the phase U and the phase V may be selected as the specified phases for the remaining period. The reason why the specified phase is variable when the auxiliary device current supply control is performed is that the q-axis current may not become zero in a case where the specified phase is fixed to one or two phases, depending on the position of the rotor 11.

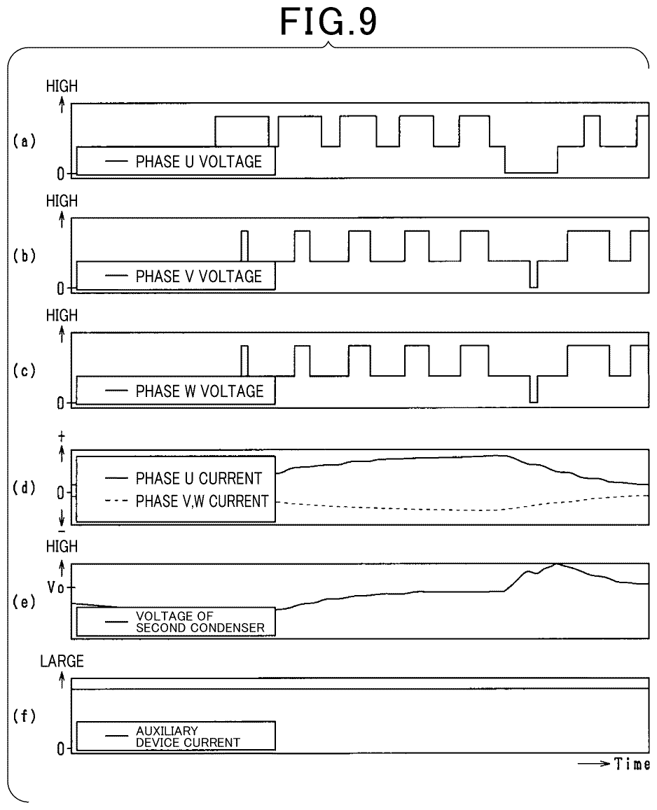

FIG. 9 shows an example of waveforms when the auxiliary device current supply control is performed. In FIG. 9, part (a) shows the transition of the voltage applied to the phase U winding 13U, part (b) shows the transition of the voltage applied to the phase V winding 13V, part (c) shows the transition of the voltage applied to the phase W winding 13W, part (d) shows the transition of the current flowing in each of the phase winding 13U to 13W, part (e) shows the transition of the voltage between terminals of the second capacitor 22, and part (f) shows the transition of the auxiliary currents flowing in the DC-DC converter 40 and the electric compressor 41. In FIG. 9, parts (a) to (c) show the voltage of each phase when the negative terminal of storage battery 20 is the reference potential (0 V), and in part (d), the solid line shows the current flowing in the phase U winding 13U, and the dotted line shows the current flowing in each of the phase V winding 13V and the phase W winding 13W.

Performing the auxiliary device current supply control increases the current flowing in each of the windings 13U to 13W and prevents a large drop in voltage between terminals in the second capacitor 22. The voltage between terminals of the series-connected element of the first capacitor 21 and the second capacitor 22 should be controlled within the proper voltage range, which includes the median Vo (e.g. 400V) of voltage between terminals (e.g. 800V). The upper voltage limit of the proper voltage range may be defined based on the allowable voltage applied to the DC-DC converter 40 and the electric compressor 41, and the lower voltage limit of the proper voltage range may be defined based on the operable voltage of the DC-DC converter 40 and the electric compressor 41. The proper voltage range may be defined based on the withstand voltage of each of the switches SUH to SWL and QU to QW.

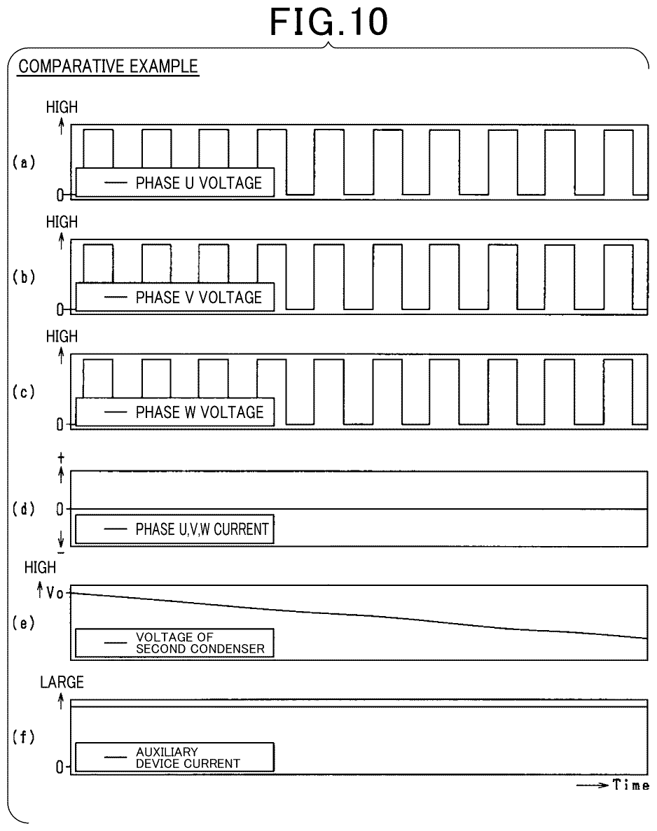

FIG. 10 shows the respective waveforms when the normal inverter control is performed and the command torque Trq* is 0, as a comparative example, unlike this embodiment. FIG. 10 part (a) to part (f) correspond to FIG. 9 (a) to part (f) respectively.

When the command torque Trq* is 0 and the normal inverter control is performed, for example, each of the switches SUH to SWL and QU to QW are turned on and off synchronously to output the same voltage in each phase, and the current flowing in each of the phase windings 13U to 13W is set to 0. In FIG. 10, part (a) to part (c) show the transition of each phase voltage when each of the phase clamp switches QU to QW and each of the phase lower arm switch SUL to SWL are turned on alternately.

When the current in each of the phase windings 13U-13W is zero, the storage battery 20 does not supply power to the second capacitor 22 via the inverter 30 and each of the phase windings 13U to 13W, resulting in a voltage drop between terminals in the second capacitor 22. As a result, the possibility arises that current cannot be supplied to the DC-DC converter 40 and the electric compressor 41.

According to this embodiment detailed above, the following effects can be obtained.

When it is determined that the suppliable current value Is to the DC-DC converter 40 and the electric compressor 41 using the storage battery 20 as the power supply source is less than the required current value In of the DC-DC converter 40 and the electric compressor 41, the switches SUH to SWL and QU to QW are controlled to cause the current flowing into each of the phase windings 13U to 13W to be larger than when it is determined that the suppliable current value Is is equal to or greater than the required current value In. When the current flowing into each of the phase windings 13U to 13W is increased, for example, the period when current is supplied to the second capacitor 22 in one electric angle cycle may become longer, and the current flowing into the second capacitor 22 also may become larger. Therefore, according to this embodiment, the voltage drop of the second capacitor 22 can be suppressed.

The larger the required current value In of the DC-DC converter 40 and the electric compressor 41, the larger the size of the instruction current vector Ia is increased. Each of the switches SUH to SWL and QU to QW is controlled so that the current supplied to the second capacitor 22 increases as the size of the instruction current vector Ia is increased. As a result, the current supplied to the DC-DC converter 40 and the electric compressor 41 is increased according to the increase in the required current value In, which allows the voltage drop of the second capacitor 22 to be suppressed suitably.

When it is determined that the suppliable current value Is is less than the required current value In, each of the switches SUH to SWL, QU to QW is controlled to increase the d-axis current than when the suppliable current value Is is equal to or greater than the required current value In. This allows the d-axis current to be intentionally increased to increase the current supplied to the DC-DC converter 40 and the electric compressor 41. Since the increase in the d-axis current increases the reactive current that does not contribute to torque generation, it is possible to suppress the actual torque of the rotor 11 from deviating significantly from the command torque Trq*.

Each of the switches SUH to SWL, QU to QW is controlled so that the d-axis current is increased and the operating point determined by the d-axis current and q-axis current in each of the phase windings 13U to 13W is on the equal torque curve of the motor 10 when the suppliable current value Is is determined to be equal to or greater than the required current value In. This can suppress the voltage drop of the second capacitor 22, suppress the torque fluctuation of the motor 10, and suppress the feeling of discomfort to the user of the vehicle 100.

When the vehicle 100 is stopped, the current value that can flow in each phase of the windings 13U to 13W is small because the rotor 11 of motor 10 is not rotated. Therefore, when the rotor 11 is not driven to rotate and the auxiliary device current supply control is performed, by allowing the d-axis current to flow in, the current vector is increased and the current value that can flow in each of the phase winding 13U to 13W is increased. As a result, the power that can be supplied to the second capacitor 22 can be secured even when the vehicle 100 is stopped.

The q-axis current is set to 0, when the auxiliary device current supply control is performed in the case of maintaining the rotor 11 in the stopped state of rotation. As a result, the rotation of the rotor 11 is suppressed, the vehicle 100 can be kept in the stopped state, and the user of the vehicle 100 is prevented from feeling uncomfortable.

### Second Embodiment

A second embodiment is described below with reference to the drawings, focusing on the differences from the first embodiment. In this embodiment, the DC-DC converter 40 and the electric compressor 41 are connected in parallel to the first capacitor 21 (another example of “target capacitor”) instead of the second capacitor 22.

When the DC-DC converter 40 and the electric compressor 41 are connected in parallel to first capacitor 21, the voltage of first capacitor 21 can drop significantly when the current value supplied to the DC-DC converter 40 and the electric compressor 41 using storage battery 20 as the power supply source falls below the required current value In of the DC-DC converter 40 and the electric compressor 41. As a result, the DC-DC converter 40 and the electric compressor 41 may not be able to operate properly.

Therefore, in this embodiment, the control device 50 feeds the first capacitor 21 from the storage battery 20 through the inverter 30 and each if the phase windings 13U to 13W by controlling each of the switches SUH-SWL, QU-QW. The control device 50 may increase the size of the instruction current vector Ia as shown in FIG. 4, the larger the required current value In of the DC-DC converter 40 and the electric compressor 41. The control device 50 may perform the auxiliary device current supply control when the control device 50 determines that the suppliable current value Is is less than the required current value In, as explained in FIGS. 5 and 6.

In this embodiment, when the control device 50 maintains the rotor 11 of the motor 10 in the rotation stop state and performs the auxiliary device current supply control, the control device 50, by turning on the clamp switch in the specified phase determined according to the electric angle θe of the motor 10, turning off upper arm switch in each phase, and turning on and off lower arm switch in each phase except the specified phase, have the d-axis current flows in each of the phase winding 13U to 13W.

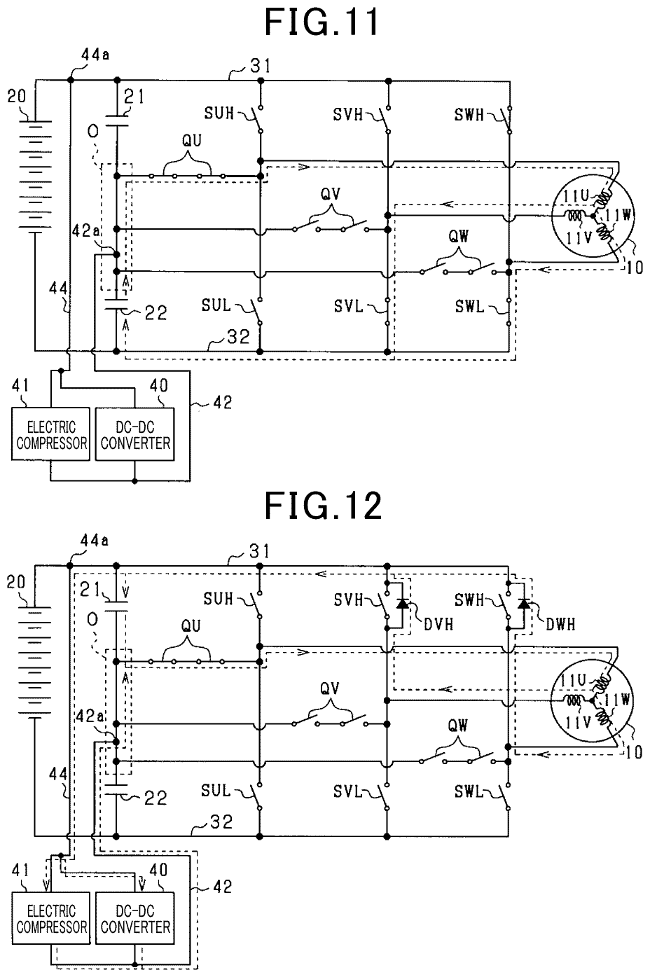

FIGS. 11 and 12 show examples of the auxiliary device current supply control in the case where the rotor 11 is stopped from rotating. Here, a positive bus terminal 44a is provided to the positive bus 31 so that the DC-DC converter 40 and the electric compressor 41 can be connected in parallel to first capacitor 21. The positive bus terminal 44a is an external terminal to connect the electronic equipment outside the inverter to the inverter 30. The positive terminal of the electric compressor 41 is connected to the positive bus terminal 44a via a positive line 44. The positive terminal of DC-DC converter 40 is connected to positive line 44. The negative terminal of the electric compressor 41 is connected to the neutral point terminal 42a via the neutral line 42. The negative terminal of the DC-DC converter 40 is connected to the neutral line 42. In the following, we will discuss the case where the specific phase is phase U.

When the specified phase is phase U, the phase U clamp switch QU is turned on, the phase V clamp switch QV and the phase W clamp switch QW, each of the phase upper arm switch SUH to SWH and the phase U lower arm switch SUL are turned off, and the phase V lower arm switch SVL and the phase W lower arm switch SWL are turned on and off.

FIG. 11 shows the current path when the phase V lower arm switch SVL and the phase W lower arm switch SWL are turned on. In this case, current flows in a closed circuit that includes the second capacitor 22, the phase U clamp switch QU, each of the phase windings 13U to 13W, the phases V lower arm switch SVL and the phase W lower arm switch SWL. This causes magnetic energy to be stored in each of the phase windings 13U, 13V, 13W.

FIG. 12 shows the current path when the phases V lower arm switch SVL and the phase W lower arm switch SWL are turned off. In this case, a closed circuit is formed including the first capacitor 21, the DC-DC converter 40 and the electric compressor 41, the phase U clamp switch QU, each of the phase windings 13U to 13W, the phase V upper arm diodes DVH, and the phase W upper arm diodes DWH, and current flows as the magnetic energy stored in each of the phase windings 13U, 13V and 13W is released. This feeds the first capacitor 21, the DC-DC converter 40 and the electric compressor 41.

When the specified phase is phase V, the phase V clamp switch QV is turned on, the phase U clamp switches QU, the phase W clamp switch QW, each of the phase upper arm switches SUH to SWH and the phase V lower arm switch SVL are turned off, and the phase U lower arm switch SUL and the phase W lower arm switch SWL are turned on and off. When the specified phase is phase W, the phase W clamp switch QW is turned on, the phase U clamp switch QU, the phase V clamp switch QV, each of the phase upper arm switch SUH to SWH and the phase W lower arm switch SWL are turned off, and the phase U lower arm switch SUL and the phase V lower arm switch SVL are turned on and off.

When the specified phase is phase U and phase V, the phase U clamp switch QU and the phase V clamp switch QV are turned on, the phase W clamp switch QW, each of the phase upper arm switch SUH to SWH, the phase U lower arm switch SUL and the phase V lower arm switch SVL are turned off, and the phase W lower arm switch SWL is turned on and off. When the specified phase is phase V and phase W, the phase V clamp switch QV and the phase W clamp switch QW are turned on, the phase U clamp switch QU, each of the phase upper arm switch SUH to SWH, the phase V lower arm switch SVL and the phase W lower arm switch SWL are turned off, and the phase U lower arm switch SUL is turned on and off. When the specified phase is phase U and phase W, the phase U clamp switch QU and the phase W clamp switch QW are turned on, the phase V clamp switch QV, each of the phase upper arm switch SUH to SWH, the phase U lower arm switch SUL and the phase W lower arm switch SWL are turned off, and the phase V lower arm switch SVL is turned on and off.

As in the first embodiment, the specific phase may be variable, not necessarily invariant, during the period when the auxiliary device current supply control is performed.

### Another Embodiments

The above embodiment may be modified, for example, as follows.

The control device 50 may set the instruction current vector to vary periodically in the feedback control when performing the auxiliary device current supply control. In this case, for example, the control device 50 may set Ia2 and Ia3 shown in FIG. 6 alternately as the instruction current vector when performing the auxiliary device current supply control.

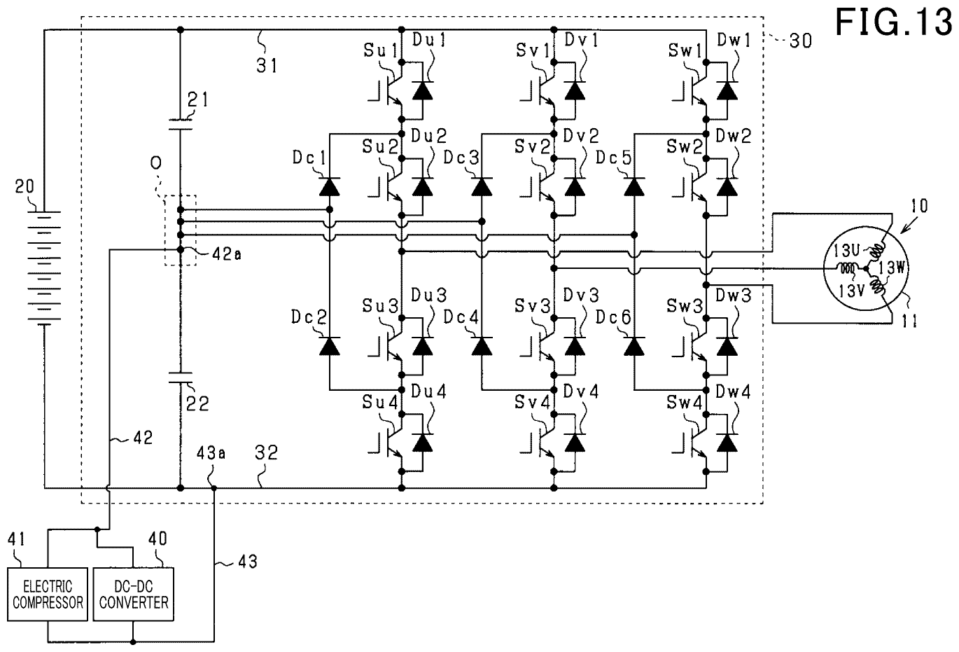

The inverter 30 is not limited to a T-type three-level inverter but can be a neutral point clamp type three-level inverter, for example. As shown in FIG. 13, the inverter 30 may have phase U first to fourth switches Su1 to Su4, phase V first to fourth switches Sv1 to Sv4, phase W first to fourth switches Sw1 to Sw4 and first to sixth clamp diodes Dc1 to Dc6. In this embodiment, voltage-controlled semiconductor switching devices are used as each switch Su1 to Su4, Sv1 to Sv4, and Sw1 to Sw4, more specifically, IGBTs are used. In this case, the positive terminal of each of the switches Su1-Su4, Sv1-Sv4, and Sw1-Sw4 is the collector, and the negative terminal s are the emitter. In FIG. 13, the same configuration as shown in FIG. 2 is marked with the same symbol for convenience.

In this embodiment, the phase U first to fourth switches Su1 to Su4 are connected in series in the form of the emitter and the collector being connected to each other. The collector of the phase U first switch Su1 is connected to the positive terminal of the storage battery 20 via the positive bus 31 and the emitter of the phase U fourth switch Su4 is connected to the negative terminal of the storage battery 20 via the negative bus 32. The connection point of the phase U second switch Su2 and the phase U third switch Su3 is connected to the first terminal of the phase U winding 13U of the motor 10. The cathode of the first clamping diode Dc1 is connected to the connection point of the phase U first switch Su1 and the phase U second switch Su2, and the anode of the first clamping diode Dc1 is connected to the cathode of the second clamping diode Dc2. The anode of the second clamp diode Dc2 is connected to the connection point of the phase U third switch Su3 and the phase U fourth switch Su4. The freewheel diodes Du1, Du2, Du3, and Du4 are connected in reverse parallel to the phase U switches Su1, Su2, Su3, and Su4 respectively.

The phase V first to fourth switches Sv1 to Sv4 are connected in series in the form of emitters and collectors being connected to each other. The collector of the phase V first switch Sv1 is connected to the positive terminal of the storage battery 20 via the positive bus 31 and the emitter of the phase V fourth switch Sv4 is connected to the negative terminal of the storage battery 20 via the negative bus 32. The connection point of the phase V second switch Sv2 and the phase V third switch Sv3 is connected to the first terminal of the phase V winding 13V of the motor 10. The cathode of the third clamping diode Dc3 is connected to the connection point of the phase V first switch Sv1 and the phase V second switch Sv2, and the cathode of the fourth clamping diode Dc4 is connected to the anode of the third clamping diode Dc3. The anode of the fourth clamp diode Dc4 is connected to the connection point of the phase V third switch Sv3 and the phase V fourth switch Sv4. The freewheel diodes Dv1, Dv2, Dv3, and Dv4 are connected in reverse parallel to the phase V switches Sv1, Sv2, Sv3, and Sv4 respectively.

The phase W first to fourth switches Sw1 to Sw4 are connected in series in the form of emitters and collectors being connected to each other. The collector of the phase W first switch Sw1 is connected to the positive terminal of the storage battery 20 via the positive bus 31 and the emitter of the phase W fourth switch Sw4 is connected to the negative terminal of the storage battery 20 via the negative bus 32. The connection point of the phase W second switch Sw2 and the phase W third switch Sw3 is connected to the first terminal of the phase W winding 13W of the motor 10. The cathode of the fifth clamp diode Dc5 is connected to the connection point of the phase W first switch Sw1 and the phase W second switch Sw2, and the anode of the fifth clamp diode Dc5 is connected to the cathode of the sixth clamp diode Dc6. The anode of the sixth clamp diode Dc6 is connected to the connection point of the phase W third switch Sw3 and the phase W fourth switch Sw4. The freewheel diodes Dw1, Dw2, Dw3, and Dw4 are connected in reverse parallel to the phase W switches Sw1, Sw2, Sw3, and Sw4 respectively.

The neutral point O is connected to the connection points of the first and second clamping diodes Dc1 and Dc2, the third and fourth clamping diodes Dc3 and Dc4, and the fifth and sixth clamping diodes Dc5 and Dc6.

As in the first embodiment, the control device 50 may control each of the switches Su1 to Su4, Sv1 to Sv4, and Sw1 to Sw4 so that the size of the instruction current vector Ia is increased when the required current value In of the DC-DC converter 40 and the electric compressor 41 is larger. As in the first embodiment, the control device 50 may perform the auxiliary device current supply control when it is determined that the suppliable current value Is is less than the required current value In.

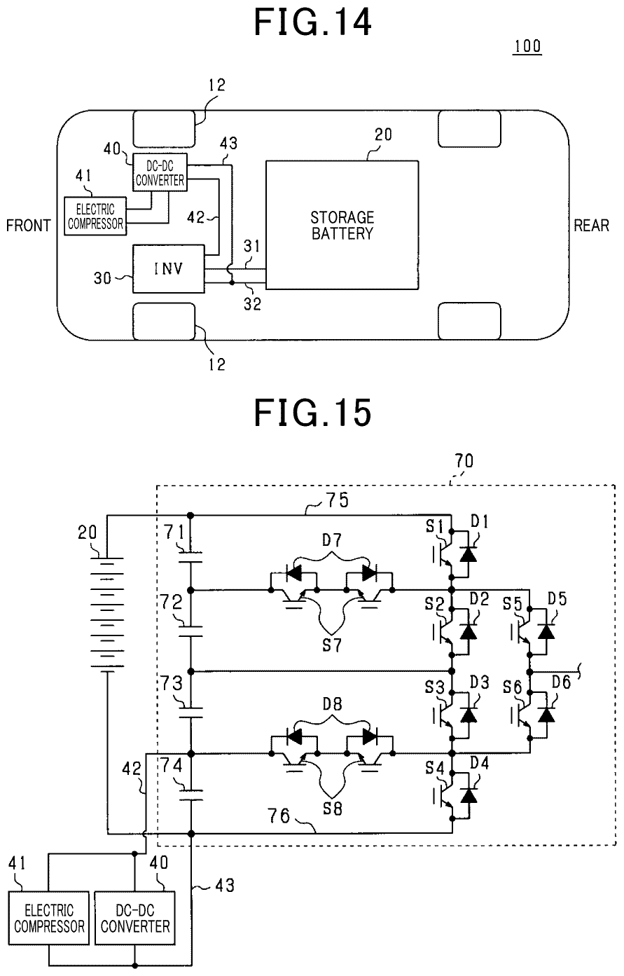

The connection manner of the storage battery 20, the inverter 30, the DC-DC converter 40 and the electric compressor 41 may be changed. For example, as shown in FIG. 14, the electric compressor 41 may be connected to the DC-DC converter 40 in a configuration where the neutral point O of the inverter 30 is connected to the DC-DC converter 40 via the neutral line 42 and the negative bus 32 is connected to the DC-DC converter 40 the via negative line 43. In this case, the DC-DC converter 40 may be configured with a connector that allows connection to the neutral line 42 and a connector that allows connection to the negative line 43, and the electric compressor 41 may be connected to the DC-DC converter 40.

The inverter may be a multi-level inverter with four or more levels. FIG. 15 shows only the phase U arm of a five-level inverter 70. In FIG. 15, the control unit is omitted and the same configuration as shown in FIG. 2 is indicated with the same symbol for convenience.

The inverter 70 has first to eighth switches S1 to S8 and first to fourth capacitors 71 to 74. In this embodiment, IGBTs are used as each of the switches S1 to S8. Freewheeling diode D1, D2, D3, D4, D5, D6, D7, D8 are connected in reverse parallel to switches S1, S2, S3, S4, S5, S6, S7, S8 respectively.

The first to fourth switches S1 to S4 are connected in series in a manner that the emitter is connected to the collector. The series-connected element of the first to fourth switches S1 to S4 are connected in parallel to the series-connected element of the first to fourth capacitor 71 to 74. The series-connected element of the first to fourth capacitor 71 to 74 are connected in parallel to the series-connected element of the first to fourth capacitor 71 to 74 are connected in parallel to the storage batteries 20. Specifically, the positive terminal of storage battery 20, the collector of switch S1 and the positive bus terminal of the first capacitor 71 are connected by a positive bus 75 such as bus bars. The negative terminal of storage battery 20, the emitter of the fourth switch S4 and the negative bus terminal of the capacitor 74 are connected by a negative bus 76, such as a bus bar.

The collector of the fifth switch S5 is connected to the connection point of the first switch S1 and the second switch S2. The collector of the sixth switch S6 is connected to the emitter of the fifth switch S5. The emitter of the sixth switch S6 is connected to the connection point of the third switch S3 and the fourth switch S4. The first terminal of the phase U winding 13U, not shown, is connected to the connection point of the fifth switch S5 and the sixth switch S6.

Each of the switches included in the seventh switch S7 is connected to each other's emitters. One collector of each of the switches included in the seventh switch S7 is connected to the connection point of the first switch S1 and the second switch S2, and the other collector is connected to the connection point of the first capacitor 71 and the second capacitor 72. Each of the switches included in the eighth switch S8 is connected to each other's emitters. One collector of each switch included in the eighth switch S8 is connected to the connection point of the third switch S3 and the fourth switch S4, and the other collector is connected to the connection point of the third capacitor 73 and the fourth capacitor 74. The connection point of the second switch S2 and the third switch S3 is connected to the connection point of the second capacitor 72 and the third capacitor 73.

In this embodiment, the DC-DC converter 40 and the electric compressor 41 are connected in parallel to the fourth capacitor 74 as “target capacitor”. Specifically, the positive terminal of the electric compressor 41 is connected to the connection point of the third capacitor 73 and the fourth capacitor 74 via the neutral line 42, and the negative terminal of electric compressor 41 is connected to the negative bus 76 via the negative line 43. The positive terminal of the DC-DC converter 40 is connected to the neutral line 42 and the negative terminal of the DC-DC converter 40 is connected to the negative line 43. In this case, the controller should control each switch S1 to S8, considering that the voltage of the fourth capacitor 74 drops significantly.

The DC-DC converter 40 and the electric compressor 41 may be connected in parallel to capacitor other than the capacitor 74 of the first to fourth capacitor 71 to 74. The DC-DC converter 40 and the electric compressor 41 may be connected in parallel to series-connected element of capacitors, including any two or three of the first to fourth capacitor 71 to 74.

In the first and second embodiments, in each phase clamp switch, instead of having their sources connected to each other, they may have their drains connected to each other. In this case, for example, one source of each switch included in the phase U clamp switch QU should be connected to the connection point of the phase U upper arm switch SUH and the phase U lower arm switch SUL, and the other source should be connected to the neutral point O.

In the first embodiment, the semiconductor switches included in the inverter 30 are not limited to N-channel MOSFETs, but may be, for example, IGBTs. In the configurations shown in FIGS. 13 and 15 above, the semiconductor switches included in the inverter are not limited to IGBTs but may also be N-channel MOSFETs.

The motor is not limited to those in which the windings of each phase are star-connected but may also be delta-connected. The motor and inverter are not limited to three-phase motors but may be 2-phase motors or motors with 4 or more phases.

The inverter, motor, and control unit are not limited to vehicles, but can also be installed in a moving vehicle such as an aircraft or a ship, for example. If the moving object is an aircraft, the motor will be the flight power source for the aircraft, and if the moving object is a ship, the motor will be the propulsion power source for the ship. The destination of the inverter, motor, and control unit is not limited to a mobile vehicle.

The control unit and methods described in this disclosure may be realized by a dedicated computer provided by configuring a processor and memory programmed to perform one or more functions embodied in a computer program. Alternatively, the control unit and methods described in this disclosure may be realized by a dedicated computer provided by configuring the processor with one or more dedicated hardware logic circuits. Alternatively, the control unit and its methods described in this disclosure may be realized by one or more dedicated computers provided by a combination of a processor and memory programmed to perform one or more functions and a processor configured by one or more dedicated hardware logic circuits. The computer program may also be stored on a computer-readable non-transitory recording medium as instructions to be executed by a computer.

The following is a description of the characteristic configurations extracted from each of the above-mentioned embodiments.

### [Configuration 1]

A control device (50) for a multi-level inverter (30, 70),
wherein the multi-level inverter includes:
a plurality of capacitors (21, 22, 71-74) connected in series; and
a plurality of switches (SUH to SWL, QU to QW, Su1 to Sw4, S1 to S8) electrically connected to at least one of the plurality of capacitors and at least one of a plurality of windings (13U to 13W) of the motor (10),
wherein the control device controls the plurality of switches to cause the multi-level inverter to output one of the multiple voltages that can be output using a series-connected element of the plurality of capacitors,
the series-connected element of the plurality of capacitors can be connected in parallel to a power source (20),
an electronic equipment (40, 41) can be connected in parallel to at least one of target capacitors that is part of the plurality of capacitors, and
the control device includes:
a determination unit that determines whether a suppliable current value to the electronic equipment is less than a required current value of the electronic equipment; and
a control unit that controls, when it is determined that the suppliable current value is less than the required current value, the plurality of switches so that current flowing in the plurality of windings is larger than when the suppliable current value is determined to be equal to or greater than the required current value.

### [Configuration 2]

The control device according to configuration 1 wherein,
the control unit, by controlling the plurality of switches, increases the current value supplied from the power source to the at least one of target capacitors via the multi-level inverter and the plurality of windings as the required current value increases.

### [Configuration 3]

A control device (50) for a multi-level inverter (30, 70),
wherein the multi-level inverter includes:
a plurality of capacitors (21, 22, 71-74) connected in series; and
a plurality of switches (SUH to SWL, QU to QW, Su1 to Sw4, S1 to S8) electrically connected to at least one of the plurality of capacitors and at least one of a plurality of windings (13U to 13W) of the motor (10),
wherein the control device controls the plurality of switches to cause the multi-level inverter to output one of the multiple voltages that can be output using a series-connected element of the plurality of capacitors,
the series-connected element of the plurality of capacitors can be connected in parallel to a power source (20),
an electronic equipment (40, 41) can be connected in parallel to at least one of target capacitors that is part of the plurality of capacitors, and
the control device includes a control unit that increases current supplied from the power source to the at least one of target capacitors via the multi-level inverter and the plurality of windings as a required current value of the electronic equipment increases, by controlling the plurality of switches.

### [Configuration 4]

The control device according to configuration 1 or 2 wherein,
the control unit controls, when it is determined that the suppliable current value is less than the required current value, the plurality of switches so that a d-axis current flowing in the plurality of windings is larger than when the suppliable current value is determined to be equal to or greater than the required current value.

### [Configuration 5]

The control device according to configuration 4 wherein,
the control unit controls, when it is determined that the suppliable current value is less than the required current value, the plurality of switches so that an operating point determined by the d-axis current and a q-axis current flowing in the winding is on an equal torque curve of the motor, the equal torque curve being a torque curve on which a torque, determined when the suppliable current value is determined to be equal to or greater than the required current value.

### [Configuration 6]

The control device according to any one of configurations 1 to 5 wherein,
the multi-level inverter is, a three-level inverter,
the plurality of capacitors includes a first capacitor (21) and a second capacitor (22),
the plurality of switches (SUH to SWL, QU to QW, Su1 to Sw4) electrically connects the plurality of windings respectively to any one of a positive terminal of first capacitor, a neutral point that is a connection point of a negative terminal of the first capacitor and a positive terminal of the second capacitor, and a negative terminal of the second capacitor, and
the control unit controls the plurality of switches to cause the multi-level inverter to output one of the three different voltages that can be output using a series-connected element of the plurality of capacitors.

### [Configuration 7]

The control device according to any one of configurations 1, 2, 4, or 5 wherein,
the control unit, when it is determined that the suppliable current value is less than the required current value and the rotor (11) of the motor is maintained in a rotation stop state, controls the plurality of switch so that a q-axis current flowing in the plurality of windings is substantially 0 and a d-axis current flows in the plurality of windings.

### [Configuration 8]

The control device according to configuration 7 wherein,
the multi-level inverter is a three-level inverter,
the plurality of capacitors includes a first capacitor (21) and a second capacitor (22),
the plurality of switches includes a plurality of upper arm switches (SUH to SWH) and a plurality of lower arm switches (SUL to SWL) for three phases,
each of the plurality of the upper arm switches and the plurality of the lower arm switches that correspond to the same phase of the three phases are connected in series,
the multi-level inverter further includes a plurality of clamp switches (QU to QW) for three phases, each of the plurality of clamp switching between conduction and interruption of current between a neutral point, that is a connection point of a negative terminal of the first capacitor and a positive terminal of the second capacitor, and one of the plurality of windings of the corresponding phase,
the control unit controls the plurality of switches to cause the multi-level inverter to output one of the three different voltages that can be output using a series-connected element of the plurality of capacitors,
the at least one of target capacitors is the second capacitor, and
the control unit turns on the clamp switch corresponding to at least one specific phases determined by an electric angle of the motor, turns off the plurality of the lower arm switches, and turns on and off part of the plurality of upper arm switch corresponding to at least one of the phases other than the at least one specific phases, so that a d-axis current flows in the plurality of windings.

### [Configuration 9]

The control device according to configuration 7 wherein,
the multi-level inverter is a three-level inverter,
the plurality of capacitors includes a first capacitor (21) and a second capacitor (22),
the plurality of switches includes a plurality of upper arm switches (SUH to SWH) and a plurality of lower arm switches (SUL to SWL) for three phases,
each of the plurality of the upper arm switches and the plurality of the lower arm switches that correspond to the same phase of the three phases are connected in series,
the multi-level inverter further includes s a plurality of clamp switches (QU to QW) for three phases, each of the plurality of clamp switching between conduction and interruption of current between a neutral point, that is a connection point of a negative terminal of the first capacitor and a positive terminal of the second capacitor, and one of the plurality of windings of the corresponding phase,
the control unit controls the plurality of switches to cause the multi-level inverter to output one of the three different voltages that can be output using a series-connected element of the plurality of capacitors,
the at least one of target capacitors is the first capacitor, and
the control unit turns on the clamp switch corresponding to at least one specific phases determined by an electric angle of the motor, turns off the plurality of the lower arm switches, and turns on and off part of the plurality of upper arm switch corresponding to at least one of the phases other than the at least one specific phases, so that a d-axis current flows in the plurality of windings.

Although this disclosure has been described in accordance with examples, it is understood that this disclosure is not limited to said examples or structures. The present disclosure also encompasses various variations and transformations within the scope of equality. In addition, various combinations and forms, as well as other combinations and forms including only one element, more or less, thereof, also fall within the scope and idea of this disclosure.

What is claimed is:

1. A control device for a multi-level inverter,
wherein the multi-level inverter comprises:
a plurality of capacitors connected in series; and
a plurality of switches electrically connected to at least one of the plurality of capacitors and at least one of a plurality of windings of the motor,
wherein the control device controls the plurality of switches to cause the multi-level inverter to output one of the multiple voltages that can be output using a series-connected element of the plurality of capacitors,
the series-connected element of the plurality of capacitors can be connected in parallel to a power source,
an electronic equipment can be connected in parallel to at least one of target capacitors that is part of the plurality of capacitors, and
the control device comprises:
a determination unit that determines whether a suppliable current value to the electronic equipment is less than a required current value of the electronic equipment; and
a control unit that controls, when it is determined that the suppliable current value is less than the required current value, the plurality of switches so that current flowing in the plurality of windings is larger than when the suppliable current value is determined to be equal to or greater than the required current value.

2. The control device according to claim 1 wherein,
the control unit, by controlling the plurality of switches, increases the current value supplied from the power source to the at least one of target capacitors via the multi-level inverter and the plurality of windings as the required current value increases.

3. A control device for a multi-level inverter,
wherein the multi-level inverter comprises:
a plurality of capacitors connected in series; and
a plurality of switches electrically connected to at least one of the plurality of capacitors and at least one of a plurality of windings of the motor,
wherein the control device controls the plurality of switches to cause the multi-level inverter to output one of the multiple voltages that can be output using a series-connected element of the plurality of capacitors,
the series-connected element of the plurality of capacitors can be connected in parallel to a power source,
an electronic equipment can be connected in parallel to at least one of target capacitors that is part of the plurality of capacitors, and
the control device comprises a control unit that increases current supplied from the power source to the at least one of target capacitors via the multi-level inverter and the plurality of windings as a required current value of the electronic equipment increases, by controlling the plurality of switches.

4. The control device according to claim 1 wherein,
the control unit controls, when it is determined that the suppliable current value is less than the required current value, the plurality of switches so that a d-axis current flowing in the plurality of windings is larger than when the suppliable current value is determined to be equal to or greater than the required current value.

5. The control device according to claim 4 wherein,
the control unit controls, when it is determined that the suppliable current value is less than the required current value, the plurality of switches so that an operating point determined by the d-axis current and a q-axis current flowing in the winding is on an equal torque curve of the motor, the equal torque curve being a torque curve on which a torque, determined when the suppliable current value is determined to be equal to or greater than the required current value.

6. The control device according to claim 1 wherein,
the multi-level inverter is, a three-level inverter,
the plurality of capacitors includes a first capacitor and a second capacitor,
the plurality of switches electrically connects the plurality of windings respectively to any one of a positive terminal of first capacitor, a neutral point that is a connection point of a negative terminal of the first capacitor and a positive terminal of the second capacitor, and a negative terminal of the second capacitor, and
the control unit controls the plurality of switches to cause the multi-level inverter to output one of the three different voltages that can be output using a series-connected element of the plurality of capacitors.

7. The control device according to claim 1 wherein,
the control unit, when it is determined that the suppliable current value is less than the required current value and the rotor of the motor is maintained in a rotation stop state, controls the plurality of switch so that a q-axis current flowing in the plurality of windings is substantially 0 and a d-axis current flows in the plurality of windings.

8. The control device according to claim 7 wherein,
the multi-level inverter is a three-level inverter,
the plurality of capacitors includes a first capacitor and a second capacitor,
the plurality of switches includes a plurality of upper arm switches and a plurality of lower arm switches for three phases,
each of the plurality of the upper arm switches and the plurality of the lower arm switches that correspond to the same phase of the three phases are connected in series,
the multi-level inverter further comprises a plurality of clamp switches for three phases, each of the plurality of clamp switching between conduction and interruption of current between a neutral point, that is a connection point of a negative terminal of the first capacitor and a positive terminal of the second capacitor, and one of the plurality of windings of the corresponding phase,
the control unit controls the plurality of switches to cause the multi-level inverter to output one of the three different voltages that can be output using a series-connected element of the plurality of capacitors,
the at least one of target capacitors is the second capacitor, and
the control unit turns on the clamp switch corresponding to at least one specific phases determined by an electric angle of the motor, turns off the plurality of the lower arm switches, and turns on and off part of the plurality of upper arm switch corresponding to at least one of the phases other than the at least one specific phases, so that a d-axis current flows in the plurality of windings.

9. The control device according to claim 7 wherein,
the multi-level inverter is a three-level inverter,
the plurality of capacitors includes a first capacitor and a second capacitor,
the plurality of switches includes a plurality of upper arm switches and a plurality of lower arm switches for three phases,
each of the plurality of the upper arm switches and the plurality of the lower arm switches that correspond to the same phase of the three phases are connected in series,
the multi-level inverter further comprises a plurality of clamp switches for three phases, each of the plurality of clamp switching between conduction and interruption of current between a neutral point, that is a connection point of a negative terminal of the first capacitor and a positive terminal of the second capacitor, and one of the plurality of windings of the corresponding phase,
the control unit controls the plurality of switches to cause the multi-level inverter to output one of the three different voltages that can be output using a series-connected element of the plurality of capacitors,
the at least one of target capacitors is the first capacitor, and
the control unit turns on the clamp switch corresponding to at least one specific phases determined by an electric angle of the motor, turns off the plurality of the lower arm switches, and turns on and off part of the plurality of upper arm switch corresponding to at least one of the phases other than the at least one specific phases, so that a d-axis current flows in the plurality of windings.

10. A program executed by a computer for a multi-level inverter,
wherein the multi-level inverter comprises:
a plurality of capacitors connected in series; and
a plurality of switches electrically connected to at least one of the plurality of capacitors and at least one of a plurality of windings of the motor,
wherein the program causing the computer to control the plurality of switches to cause the multi-level inverter to output one of the multiple voltages that can be output using a series-connected element of the plurality of capacitors,
the series-connected element of the plurality of capacitors can be connected in parallel to a power source,
an electronic equipment can be connected in parallel to at least one of target capacitors that is part of the plurality of capacitors, and
the program causing the computer to perform:
a determination step for determining whether a suppliable current value to the electronic equipment is less than a required current value of the electronic equipment; and
a control step for controlling, when it is determined that the suppliable current value is less than the required current value, the plurality of switches so that current flowing in the plurality of windings is larger than when the suppliable current value is determined to be equal to or greater than the required current value.

11. A multi-level inverter comprising:
a plurality of capacitors connected in series;
a plurality of switches electrically connected to at least one of the plurality of capacitors and at least one of a plurality of windings of the motor; and
a control device that controls the plurality of switches to cause the multi-level inverter to output one of the multiple voltages that can be output using a series-connected element of the plurality of capacitors,
wherein the series-connected element of the plurality of capacitors can be connected in parallel to a power source,
an electronic equipment can be connected in parallel to at least one of target capacitors that is part of the plurality of capacitors, and
the control device comprises:
a determination unit that determines whether a suppliable current value to the electronic equipment is less than a required current value of the electronic equipment; and
a control unit that controls, when it is determined that the suppliable current value is less than the required current value, the plurality of switches so that current flowing in the plurality of windings is larger than when the suppliable current value is determined to be equal to or greater than the required current value.

12. A multi-level inverter comprising:
a plurality of capacitors connected in series;
a plurality of switches electrically connected to at least one of the plurality of capacitors and at least one of a plurality of windings of the motor; and
a control device that controls the plurality of switches to cause the multi-level inverter to output one of the multiple voltages that can be output using a series-connected element of the plurality of capacitors,
wherein the series-connected element of the plurality of capacitors can be connected in parallel to a power source,
an electronic equipment can be connected in parallel to at least one of target capacitors that is part of the plurality of capacitors, and
the control device comprises a control unit that increases current supplied from the power source to the at least one of target capacitors via the multi-level inverter and the plurality of windings as a required current value of the electronic equipment increases, by controlling the plurality of switches.
